(19) United States
(12) Patent Application Publication
(10) Pub. No.: US 2018/0275768 A1
(43) Pub. Date: Sep. 27, 2018

(54) WEARABLE WIRELESS KEYBOARD

(71) Applicant: Javad Karamafrooz, Roseville, MN (US)

(72) Inventor: Javad Karamafrooz, Roseville, MN (US)

(21) Appl. No.: 15/919,538

(22) Filed: Mar. 13, 2018

Related U.S. Application Data
(60) Provisional application No. 62/476,479, filed on Mar. 24, 2017.

(51) Int. Cl. G06F 3/02

(52) U.S. Cl. CPC G06F 3/0202

(57) ABSTRACT

The present invention comprises a body-wearable, screen-free and wireless input device having a stretchable human arm sleeve composed of an elastic material, the arm sleeve having an access region within easy reach of a user's hands and fingers, a central processing unit (CPU) coupled to the access region with the CPU including a rechargeable battery powering the CPU, a Bluetooth transceiver for wireless communication with a parent device, and a universal serial bus interface for wired communication with the parent device and charging the battery, and a plurality of input electrodes located on the access region and connected to the CPU by a plurality of wirings at least partially embedded within the access region with the input electrodes forming a plurality of preset key assignments that acts as a mechanical lever or electronic switch to facilitate user communication with a wirelessly connected parent device.

### CROSS REFERENCE TO RELATED APPLICATIONS

This application claims priority to currently pending U.S. Provisional Application Ser. No. 62/476,479; filed on Mar. 24, 2017; titled WEARABLE WIRELESS KEYBOARD.

### FIELD OF THE INVENTION

This invention relates generally to portable multi-purpose wireless input devices and, more specifically to a wearable multi-purpose wireless input devices that includes keyboard functionalities.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Portable keyboards which are pocket sized and can be used at mobile locations for typing into devices such as smart phones, desktop computers and laptops, and smart televisions are known in the art. Smart phones are designed to include their version of a keyboard to enable data input. The problems with portable keyboards and smart phones are that they require a user to carry them with when the user is out and about and typically physically hold them with at least one of the user's handle in order to use them. Another problem associated with portable keyboards and smart phones are that they can be easily damage due to accidental drops, lost or misplaced, and often times hinders the user from being physically active.

The present invention is an attempt to solve the traditional short comings of portable keyboards and smart phones by providing for a body-wearable, screen-free and wireless input device that includes all the features of the traditional portable keyboards and smart phones in addition to other features not provided by the traditional portable keyboards.

### SUMMARY OF THE INVENTION

Briefly, the present invention comprises a body-wearable, screen-free and wireless input device that includes a stretchable human arm sleeve composed of an elastic material, a central processing unit (CPU) coupled to the arm sleeve with the CPU including a rechargeable battery powering the CPU, a Bluetooth transceiver for wireless communication with a parent device, a universal serial bus interface for wired communication with the parent device and charging the battery. The body-wearable, screen-free and wireless input device also includes and a plurality of input electrodes located on the arm sleeve and connected to the CPU by a plurality of wirings at least partially embedded within the arm sleeve with the plurality of input electrodes forming a plurality of preset key assignments that acts as a mechanical lever or electronic switch to facilitate user communication with a wirelessly connected parent device.

The present invention also comprises a body-wearable, screen-free and wireless input device that includes an article of clothing such as a shirt, pant, jacket or a shirt having an access region within easy reach of a user's hands and fingers while the user is either sitting or standing and a central processing unit (CPU) coupled to the access region of the article of clothing. The CPU includes a rechargeable battery powering the CPU, a Bluetooth transceiver for wireless communication with a parent device, and a universal serial bus interface for wired communication with the parent device and charging the battery. The body-wearable, screen-free and wireless input device also includes a plurality of input electrodes located on the access region of the article of clothing and connected to the CPU by a plurality of wirings at least partially embedded within the access region with the plurality of input electrodes forming a plurality of preset key assignments that acts as a mechanical lever or electronic switch to facilitate user communication with a wirelessly connected parent device with at least a portion of the plurality of pre-set key assignments forming a partial QWERTY layout. The body-wearable, screen-free and wireless input device further includes a Haptic™ feedback motor located on the article of clothing and connected to the CPU to provide to user vibratory feedback.

### BRIEF DESCRIPTION OF THE DRAWINGS

FIG. 1 is a front perspective view showing an embodiment of the present invention comprising a wearable wireless keyboard arm sleeve;

FIG. 2 is a schematic of the general components of the body-wearable, screen-free and wireless input device of the present invention;

FIG. 3 is a close-up view of an access region of a body-wearable, screen-free and wireless input device of the present invention;

FIG. 4 shows an interior of the wearable wireless keyboard arm sleeve of FIG. 1;

FIG. 5 is a front view showing an embodiment of a body-wearable, screen-free and wireless input device comprising a shirt; and

FIG. 6 is a front view showing an embodiment of a body-wearable, screen-free and wireless input device comprising a pair of pants.

### DESCRIPTION OF THE PREFERRED EMBODIMENT

The object of this invention is to design a portable wireless input device similar to that of a computer keyboard that is not only wearable on various regions of a human body including but not limited to limbs, thighs, calves, and chest but also may act, among other things, as a remote-controlled device, a mobile payment device and a health-monitoring device.

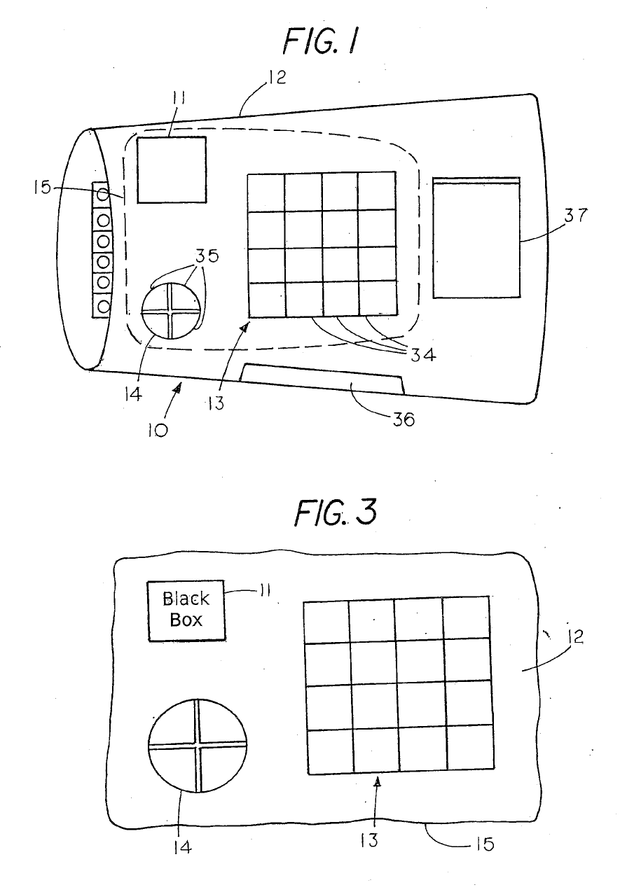

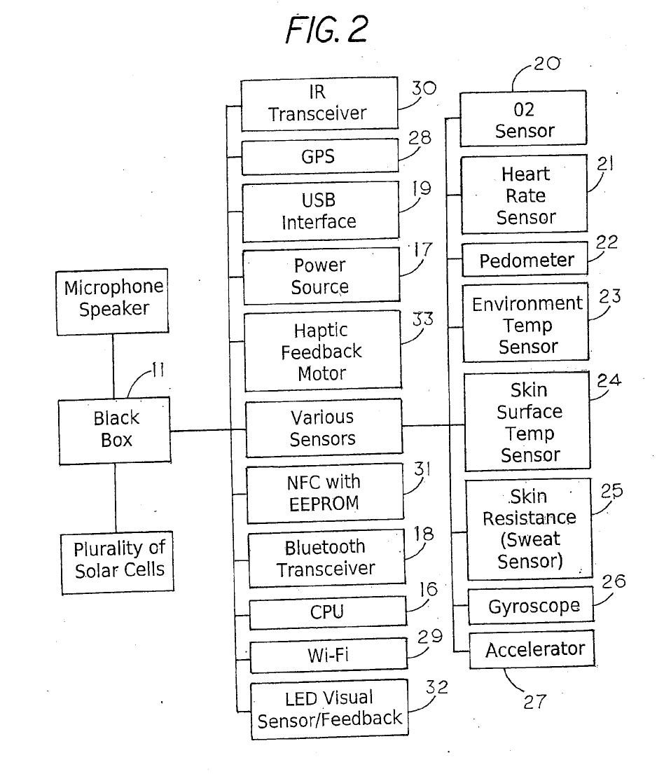

Referring to FIG. 1, FIG. 1 is a front perspective view showing an embodiment of a body-wearable, screen-free and wireless input device of the present invention comprising a wearable wireless keyboard arm or thigh sleeve 10 that has the ability to connect and communicate with its parent device(s) via various protocols such as but not limited to radio frequency (RF), infrared (IR) and Bluetooth protocol. It is noted that the feature of being screen-free or screen-less enables the present invention to be implemented to a variety of wearable materials while reducing bulk and reducing the manufacturing costs and complexities associated with display screens. Updated protocol will also enable to present invention to be used not only with standard definition and high definition screens but also with 4K and 8K screens and beyond thereby extending the use-life of the present invention. Examples of connectable parent devices include but are not limited to desktop computers, laptops and ultra books, and various mobile devices such as smart phones, tablets, Android TV Box, Google TV Box, Raspberry PI, TV Box, PS3, HTPC/IPTV. FIG. 2 is a schematic of the general components of the wearable wireless keyboard arm or thigh sleeve 10 of FIG. 1. Although not shown, wearable wireless keyboard arm or thigh sleeve 10 may also include the ability to track move and a time of flight (TOF) or distance sensor.

Wearable wireless keyboard arm or thigh sleeve 10 is composed of an elastic material having a tubular shape and preferably an elastic stretchable tapering tube 12 that is designed to be worn over a portion of a user's arm or thigh in a fitted manner either directly over the user's skin or above a layer of clothing, as long as the layer of clothing does not impede sensory input, while still retaining a gentle yet firm grip. Although not required elastic stretchable tapering tube 12 may be attached to or secured to the user's arm or thigh through the use of various types of fasteners including but not limited to snaps, buttons, zipper, Velcro™, and buckles.

Elastic stretchable tapering tube 12 includes an access region 15 thereon that is within easy reach of a user's hands and fingers when wearable wireless keyboard arm or thigh sleeve 10 is worn and in use by the user. FIG. 3 is a close-up view of the access region 15 of wearable wireless keyboard arm or thigh sleeve 10.

Wearable wireless keyboard arm sleeve 10 is shown supporting a black box 11 within access region 15, which is considered the heart and brains of the present invention.

Referring to FIGS. 1 and 2, the design of black box 11 includes a central processing unit 16, such as the latest version microprocessor and an OTG connection, coupled to the access region 15 of sleeve 12. Also coupled to the access region 15 of sleeve 12 and optionally located within the black box 11 or connected to the black box 11 is a power source such as a rechargeable battery 17 powering the central processing unit 16, a Bluetooth transceiver 18 for wireless communication with a parent device, and a universal serial bus interface 19 for wired communication with the parent device and charging the battery 17 all coupled to the access region 15 of sleeve 12.

The access region 15 of sleeve 12 may optionally include an O2 Sensor 20, a heart rate sensor 21, a pedometer 22, an environmental temperature sensor 23, a skin surface temperature sensor 24, a skin resistance/sweat sensor 25, a gyroscope 26, an accelerometer 27, a GPS 28, Wi-Fi transceiver 29, IR transceiver 30, a NFC Transceiver with native eeprom 31, and a LED visual sensor/feedback 32, and a Haptic™ feedback motor 33 to provide to user vibratory feedback. The aforementioned may also be located within the black box 11 or connected to the black box 11. In regards to the Haptic™ feedback, tactile Haptic™ technology is found in a wide number of currently-available consumer electronic devices such as tablets, smart devices, game controllers, smart phones and/or mobile phones and functions to provide a vibratory or rumble feedback from a fixed sensor button for a touch screen that is correlated to what may be happening on a screen. It is noted that a feature of the Haptic™ feedback motor 33 is that it provides the user with the sense of touch, in particular relating to the perception and manipulation of objects using the senses of touch and proprioception. Although not shown the access region 15 of sleeve 12a may further include a flash memory, a backlight, a gyroscope, and an accelerometer. The present invention may also include a low-resolution light feedback arrays (screens) such as for example=<32×32px and located on top of buttons to configure allocation for user feedback.

In more specific regards to the power source, the power source may be in the form of a miniature or micro sized battery such as a lithium battery that is traditionally charged through a direct connection to an electrical outlet or alternatively by wireless charging, kinetic, solar power charging or the various combinations.

Although not shown the access region 15 of sleeve 12 may further include other various sensors including but not limited to an ambient light sensor, a barometric, an altimeter, Microphone & speakers, a Blood glucose sensor, a pulse sensor, a body temperature sensor, and a blood pressure sensor. Access region 15 of sleeve 12 may also include various other wireless communication devices including but not limited to Radio-frequency identification (RFID).

Also coupled to access region 15 of sleeve 12 is a plurality of input connected to central processing unit 16 by a plurality of wirings at least partially embedded within the access region 15 of sleeve 12 with the plurality of input electrodes forming a plurality of preset key assignments that acts as a mechanical lever or electronic switch to facilitate user communication with a wirelessly connected parent device.

In regards to the input electrodes, when connected to its parent device wearable wireless keyboard arm sleeve 10 the input electrodes may function as a plurality of key assignment such as in the form of an arrangement of buttons or keys to act as a mechanical lever or electronic switch to communicate with its parent device(s). The plurality of key assignments may be multi-functional in that, for example, it may comprise the combinational functionality of a typical wireless keyboard, with function buttons, a mouse, a touchpad, multi-media control keys, scroll buttons, a track pad, or any of the combinations.

In the embodiment of FIGS. 1 and 3 the plurality of preset key assignments is shown forming a partial QWERTY keyboard layout and includes sixteen electrodes forming a grid of four by four key assignments 34 and four electrodes forming a circular touch pad 14 having four quadrilateral key assignments 35 comprising a quadrilateral cardinal surface resembling a tetraspeck circle. Circular touch pad 14 can function alone, when combined with a certain key press, or as a modifier in a multiplexed system consisting of all 20 keys (4×16) thereby allowing for 64+ combinations. The plurality of key assignments may either protrude from the sleeve 10 or alternatively maybe embedded into the sleeve 10.

In regards to the layout of the keyboard layout, although the keyboard layout may comprise a full or partial QWERTY layout, the keyboard may alternatively comprise other types of layouts including as but not limited to Azerty, Qwertz, Dvorak, Colemak, and Workman layouts. In terms of key assignment layout, it is proposed that the key assignments of A-Z, 0-9, =, -, ,, ., [,], ;, ', /, \, tab, capslock, backspace, return, and space should be sufficient. The aforementioned layout should allow for 13 remaining combinations to be configured by the user such as in the form of macro keys. It is noted that the modifier input can be altered to incorporate more keys such as 4->5 adding in 16 more (80).

The user, preferably, is provided with helpful visual information via an overlay on each of the key assignment or button. This overlay provides 8+ bits of information being what character/function the button correlates to in relation to the cardinal modifier and the caps lock aberrant. In addition, in order to further help users with visual information, the key assignment or button may also be backlit.

In regards to the NFC (near-field communication) with native eeprom, the NFC/eeprom preferably functions as an external wireless NFC port for an optional cell phone as well as a passive (offline) databank, e-wallets such as Paypal™, Android Pay™, Apple Pay™, and Samsung Pay. The NFC/eeprom may also be used for copy/pasting into reality, business cards, cryptocurrency such as crypto-Bitcoin addresses, a reusable post-it note. It is noted that further app support for utilization of more abstract functions as well as interfacing with the microcontroller and subsequently eeprom.

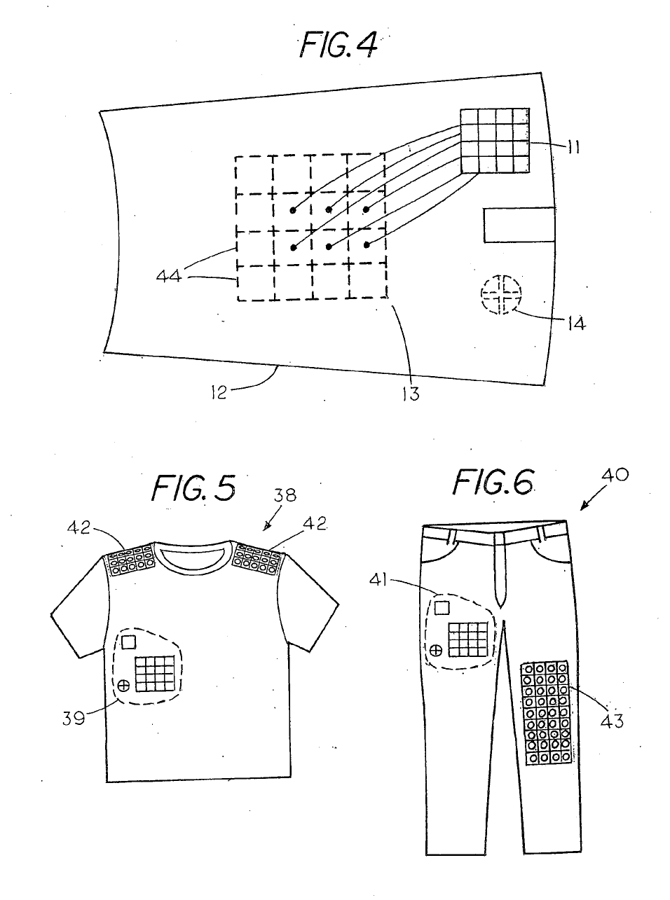

Referring to FIG. 4, FIG. 4 shows an interior of wearable wireless keyboard arm sleeve 10 and a backside of the black box 11. As shown the various may be located in the black box 11, on the backside of the key assignment/touchpad 13, or the combination. If the sensors of located on the backside of the key assignment/touchpad 13 loose or stitched wirings 44 may connect the sensors to the black box 11. Similarly, loose or stitched wirings 44 may connect the key assignment/touchpad 13 to the central processing unit 16.

Referring back to FIG. 1, additional features to the present invention may include a cellphone holder 36, a wallet sleeve and/or a business card holder 37 located somewhere that is readily accessible on sleeve 10.

Referring to FIG. 5, FIG. 5 is a front view showing an embodiment of a body-wearable, screen-free and wireless input device comprising a shirt 38 having an access region 39 within easy reach of a user's hands and fingers while the user is sitting or standing, the access region 39 supporting some if not all of the components supported by the access region 15 of wearable wireless keyboard arm or thigh sleeve 10. However, FIG. 5 also shows a plurality of solar cells 42 secured to the shoulder regions of shirt 38 for charging the rechargeable battery powering the central processing unit shirt 38.

FIG. 6 is a front view showing an embodiment of a body-wearable, screen-free and wireless input device comprising a pair of pants 40 having an access region 41 within easy reach of a user's hands and fingers while the user is sitting or standing, the access region 41 supporting some if not all of the components supported by the access region 15 of wearable wireless keyboard arm or thigh sleeve 10 and the access region 39 of shirt 38. FIG. 5 also shows a plurality of solar cells 43 secured on one of the front leg or thigh regions of pants 40 for charging the rechargeable battery powering the central processing unit pants 40.

I claim:

1. A body-wearable, screen-free and wireless input device comprising:
a stretchable human arm sleeve composed of an elastic material, said arm sleeve having an access region within easy reach of a user's hands and fingers;
a central processing unit coupled to said access region of said arm sleeve, said central processing unit including a rechargeable battery powering said central processing unit, a Bluetooth transceiver for wireless communication with a parent device, and a universal serial bus interface for wired communication with said parent device and charging said battery; and
a plurality of input electrodes located on said access region of said arm sleeve and connected to said central processing unit by a plurality of wirings at least partially embedded within said access region of said arm sleeve, said plurality of input electrodes forming a plurality of preset key assignments that acts as a mechanical lever or electronic switch to facilitate user communication with a wirelessly connected parent device.

2. The body-wearable, screen-free and wireless input device of claim 1 including a fastener to secure said arm sleeve to a user's arm.

3. The body-wearable, screen-free and wireless input device of claim 2 wherein said fastener comprises snaps, buttons, zipper, Velcro™, or buckles.

4. The body-wearable, screen-free and wireless input device of claim 1 wherein said plurality of input electrodes protrude from said access region of said arm sleeve.

5. The body-wearable, screen-free and wireless input device of claim 1 wherein said plurality of input electrodes are embedded within said access region of said arm sleeve.

6. The body-wearable, screen-free and wireless input device of claim 1 wherein said plurality of input electrodes comprises twenty electrodes and said pre-set key assignments comprises with sixteen of said electrodes forming a grid of four by four key assignments and said remaining four electrodes forming a circular touch pad having four quadrilateral key assignments.

7. The body-wearable, screen-free and wireless input device of claim 1 wherein said plurality of input electrodes are connected to said central processing unit by a plurality of wirings stitched on said access region of said arm sleeve.

8. The body-wearable, screen-free and wireless input device of claim 1 including a Haptic™ feedback motor located on said access region of said arm sleeve and connected to said central processing unit to provide to user vibratory feedback.

9. The body-wearable, screen-free and wireless input device of claim 1 including an O₂ Sensor, a heart rate sensor, a pedometer, an environmental temperature sensor, a skin surface temperature sensor, a skin resistance/sweat sensor, a gyroscope, an accelerometer, a GPS, Wi-Fi transceiver, IR transceiver, a NFC Transceiver with native eeprom, a flash memory, and a LED visual sensor/feedback each located on said access region of said access region and connected to said central processing unit.

10. The body-wearable, screen-free and wireless input device of claim 1 including a microphone and at least one speaker located on said arm sleeve.

11. The body-wearable, screen-free and wireless input device of claim 1 wherein said plurality of pre-set key assignments comprises a partial QWERTY layout.

12. The body-wearable, screen-free and wireless input device of claim 1 including solar cells secured to said arm sleeve for charging said battery.

13. A body-wearable, screen-free and wireless input device comprising:
an article of clothing having an access region within easy reach of a user's hands and fingers while said user is sitting or standing;
a central processing unit coupled to said access region of said article of clothing, said central processing unit including a rechargeable battery powering said central processing unit, a Bluetooth transceiver for wireless communication with a parent device, and a universal serial bus interface for wired communication with said parent device and charging said battery;
a plurality of input electrodes located on said access region of said article of clothing and connected to said central processing unit by a plurality of wirings at least partially embedded within said access region, said plurality of input electrodes forming a plurality of preset key assignments that acts as a mechanical lever or electronic switch to facilitate user communication with a wirelessly connected parent device with at least a portion of said plurality of pre-set key assignments forming a partial QWERTY layout; and
a Haptic™ feedback motor located on said article of clothing and connected to said central processing unit to provide to user vibratory feedback.

14. The body-wearable, screen-free and wireless input device of claim 13 wherein said plurality of input electrodes comprises twenty electrodes and said pre-set key assignments comprises with sixteen of said electrodes forming a grid of four by four key assignments and said remaining four electrodes forming a circular touch pad having four quadrilateral key assignments.

15. The body-wearable, screen-free and wireless input device of claim 14 wherein said plurality of input electrodes are connected to said central processing unit by a plurality of wirings stitched on said article of clothing.

16. The body-wearable, screen-free and wireless input device of claim 15 including an O₂ Sensor, a heart rate sensor, a pedometer, an environmental temperature sensor, a skin surface temperature sensor, a skin resistance/sweat sensor, a gyroscope, an accelerometer, a GPS, Wi-Fi transceiver, IR transceiver, a NFC Transceiver with native eeprom, a flash memory, and a LED visual sensor/feedback each located on said access region and connected to said central processing unit.

17. The body-wearable, screen-free and wireless input device of claim 16 wherein said article of clothing comprises a pair of pants.

18. The body-wearable, screen-free and wireless input device of claim 16 wherein said article of clothing comprises a shirt.

19. The body-wearable, screen-free and wireless input device of claim 16 including solar cells secured to said arm sleeve for charging said battery.

20. A body-wearable, screen-free and wireless input device comprising:
an article of clothing having an access region within easy reach of a user's hands and fingers while said user is sitting or standing;
a central processing unit coupled to said access region of said article of clothing, said central processing unit including a rechargeable battery powering said central processing unit, a Bluetooth transceiver for wireless communication with a parent device, and a universal serial bus interface for wired communication with said parent device and charging said battery;
a plurality of input electrodes located on said access region of said article of clothing and connected to said central processing unit by a plurality of wirings stitched to said access region, said plurality of input electrodes forming a plurality of preset key assignments that acts as a mechanical lever or electronic switch to facilitate user communication with a wirelessly connected parent device with at least a portion of said plurality of pre-set key assignments forming a partial QWERTY layout, said plurality of preset key assignments including sixteen electrodes forming a grid of four by four key assignments and four electrodes forming a circular touch pad having four quadrilateral key assignments;
a Haptic™ feedback motor located on said article of clothing and connected to said central processing unit to provide to user vibratory feedback;
an O₂ Sensor;
a heart rate sensor;
a pedometer;
an environmental temperature sensor;
a skin surface temperature sensor;
a skin resistance/sweat sensor;
a gyroscope, an accelerometer;
a GPS;
Wi-Fi transceiver;
IR transceiver;
a NFC Transceiver with native eeprom;
a flash memory;
a backlight;
a distance sensor;
a gyroscope;
an accelerometer
a LED visual sensor/feedback each located on said access region and connected to said central processing unit;
a microphone and at least one speaker attached to said article of clothing; and
solar cells secured to said article of clothing for charging said battery.
